(19) United States
(12) Patent Application Publication
(10) Pub. No.: US 2005/0239018 A1
(43) Pub. Date: Oct. 27, 2005

(54) Intraoral bite spacer and illumination apparatus

(76) Inventors: Scott Green, Savage, MN (US); Delon Gilbert, Portland, OR (US); Ralph Green, Scottsdale, AZ (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/832,979

(22) Filed: Apr. 27, 2004

(51) Int. Cl. A61C 5/00; A61C 3/00

(52) U.S. Cl. 433/140; 433/29

(57) ABSTRACT

An intraoral apparatus for illuminating a patient's mouth includes a bite spacer having a pair of teeth engaging structures vertically spaced apart by a spacer structure that includes a side wall. At least one self-contained light emitting device is operably mounted in the side wall of the bite spacer. The bite spacer is positionable between the teeth on either side of the patient's mouth such that the light emitting devices illuminate the other side of the patient's mouth. In one embodiment, a rechargeable battery is positioned within the bite spacer to power the light emitting devices. An induction charging circuit recharges the rechargeable battery without connections external to the bite spacer. In another embodiment, the bite spacers are adapted to interface with a recharging and sterilizing base station.

### FIELD OF THE INVENTION

The present invention relates to the field of dental devices having means to emit radiation or facilitate viewing of the work. Specifically, the present invention is a bite spacer having light emitting devices wholly contained therein.

### BACKGROUND OF THE INVENTION

Adequate illumination of a patient's mouth is necessary for dental procedures and/or oral surgery. The current technique of shining an external overhead light into the patient's mouth has many disadvantages. Illuminating the patient's mouth is often difficult. First, the patient's mouth provides a small opening for light. Second, instruments are usually placed in the patient's mouth further obstructing the dentist's view and the light source. Overhead lighting is extremely inefficient as the dentist and/or assistant spend substantial time attempting to accurately position the overhead light to hit the mouth precisely at the right angle to permit the light to be reflected by a mirrored instrument. Further, the dentist's body and dental instruments or other obstructions often interfere with outside lighting sources casting shadows inside the patient's mouth.

Fiber optic lighting has been integrated into dental instruments as one solution to help alleviate the shadowing problem of overhead lighting. The fiber optic illumination systems are generally configured to connect to an external light source by optical fibers to illuminate a spot area at the end of a handheld instrument as shown, for example, in U.S. Pat. No. 6,332,776. This approach has several drawbacks. The spot area that is illuminated is limited to a small area surrounding the distal end of the dental instrument and does not illuminate the patient's entire mouth. The optical fibers can interfere with the use of the instrument, and due to the need to continually cleaning and sterilize the dental instruments, the optical fibers tend to degrade over time. Fiber optic illumination systems are also quite expensive and increase the complexity of handheld dental instruments. Further, the use of fiber optic illumination systems may require the practitioner to give the patient a detailed explanation of the equipment and obtain patient approval prior to use.

Another dental lighting device that is mounted on the distal end of a handheld medical or dental tool is disclosed in U.S. Pat. No. 6,607,384. The handheld dental tool has a lighting device at the distal end of the tool that includes a plurality of LEDs and an LED holder encasing the LEDs. While the use of the LEDs reduces some of the problems of fiber optic illumination systems by not requiring connection to an external light source, like other handheld tool/lighting device combinations such as illuminated tongue depressors as shown in U.S. Pat. Nos. 4,643,172 and 4,807,599, the light from this handheld device is directed in only one direction and does not illuminate the patient's entire oral cavity. Further, the practitioner must hold the tool/lighting device combination while working, which can be inefficient and cumbersome.

One particular fiber optic lighting source that addresses the problem of single point handheld light sources is shown in the illuminator and lip expander as described in U.S. Pat. No. 4,592,344. A more recent approach along these lines is the Isolite™ Dryfield illuminator as disclosed in U.S. Pat. Nos. 6,022,214, 6,338,627 and 6,575,746. This device broadcasts light from inside the patient's mouth by delivering a high intensity, bright-white, fiber optic light from a light source external to the patient that is internally. The device includes a tongue and cheek retractor, a light dispersion piece and a bite block. A bite block is a rubber or plastic wedge used by most dentists to prop a patient's mouth open. The patient's teeth rest on the bite block allowing the jaw muscles to relax. Dentists and hygienists utilize a bite block for long procedures, moisture sensitive procedures and patients who experience discomfort while having to keep their mouths open for a prolonged period of time. The light dispersion piece in the Isolite™ Dryfield illuminator is coupled to a light carrier such as a fiber optic bundle that in turn is connected to the light source external to the patient. The light dispersion piece is generally U-shaped with a dispersion lens and extends beyond the bite block piece such that the light dispersion piece is effectively positioned at the rear of the patient's mouth so as to illuminate the entire interior of the mouth. Multiple fluid evacuation channels are connected to a vacuum source such that the device also serves as a fluid aspirator.

While the Isolite™ Dryfield illuminator represents an improvement over the current techniques for illuminating a patient's mouth during dental procedures, it suffers from the same drawbacks of expense, degradation over time and complication as other handheld fiber optic illumination systems. There is a continuing need for a simple, easy to use and effective system for illuminating a patient's mouth during dental procedures.

### SUMMARY OF THE INVENTION

The present invention is an intraoral apparatus for illuminating a patient's mouth that includes a bite spacer having a pair of teeth engaging structures vertically spaced apart by a spacer structure that includes a side wall. At least one self-contained light emitting device is operably mounted in the sidewall of the bite spacer. The bite spacer is positionable between the teeth on either side of the patient's mouth such that the light emitting devices illuminate the other side of the patient's mouth.

In one embodiment, a rechargeable battery is positioned within the bite spacer to power the light emitting devices. An induction charging circuit recharges the rechargeable battery without connections external to the bite spacer. In another embodiment, the bite spacers are adapted to interface with a recharging and sterilizing base station. In still another embodiment, the light emitting devices in the bite spacer include at least one light emitting device that does not activate photopolymerizable materials.

The present invention improves upon current oral illumination devices by providing a hypoallergenic, simple, cost effective and rechargeable device that cross-illuminates the oral cavity while allowing the practitioner the full use of their hands. The present invention eliminates the need to hold an illumination device as part of a handheld dental tool or the need to continually move and readjust an external light source, thereby allowing the practitioner to practice more efficiently.

It is an object of the present invention to provide a comfortable intraoral bite spacer providing shadowless rechargeable cross-illumination of the entire oral cavity.

It is an object of the invention to provide an intraoral bite spacer having means for cross-illumination with rechargeable batteries for illuminating the oral cavity.

It is yet another object of the present invention to provide a fully contained recharging base that recharges multiple intraoral bite spacers and upon closure sterilizes the bite spacers.

It is a further object of the invention to provide an intraoral bite spacer having an internal membrane power switch.

It is another object of the invention to provide an intraoral bite spacer having an internal membrane switch to orange light to block blue light and avoid curing dental composites.

### BRIEF DESCRIPTION OF THE DRAWINGS

FIG. 1 is a perspective view of the bite spacer with cross-illumination of the present invention.

FIG. 2 is an enlarged side perspective view of the bite spacer with cross-illumination of the present invention.

FIG. 3 is a top perspective view of a closed recharging station of the present invention.

FIG. 4 is a front perspective view of an open recharging station of FIG. 3.

FIG. 5 is a hidden line perspective view of an embodiment of a bite spacer.

FIG. 6 is an electrical diagram of one embodiment of the present invention.

### DETAILED DESCRIPTION OF THE PREFERRED EMBODIMENTS

Lighting is a critical factor during intraoral procedures, especially when trying to view interproximally (between the teeth) or where it is difficult to direct light. Current illumination techniques are inadequate as they cause shadows, obstruct the practitioner's view or are handheld among other deficiencies. The present invention improves on the currently available illumination techniques by providing a source of intraoral illumination contained as part of a bite spacer. Dentists routinely use bite spacers to prop open a patient's mouth during dental procedures. The patient's teeth rest on the bite spacer, allowing the jaw muscles to relax while maintaining the mouth in an open position.

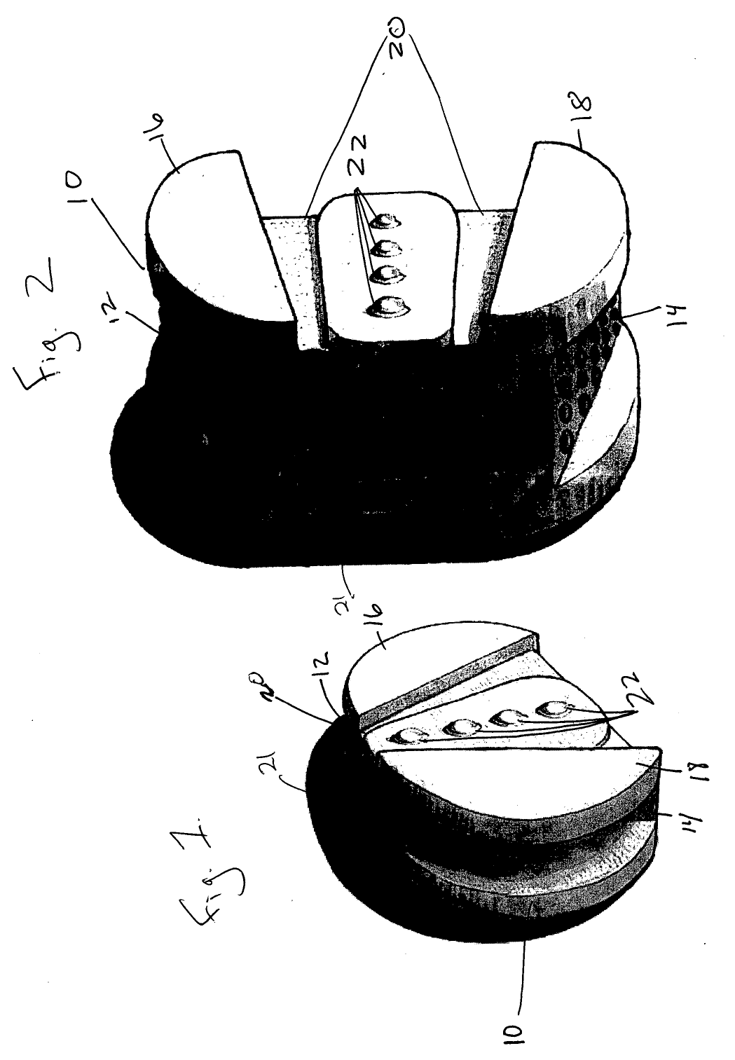

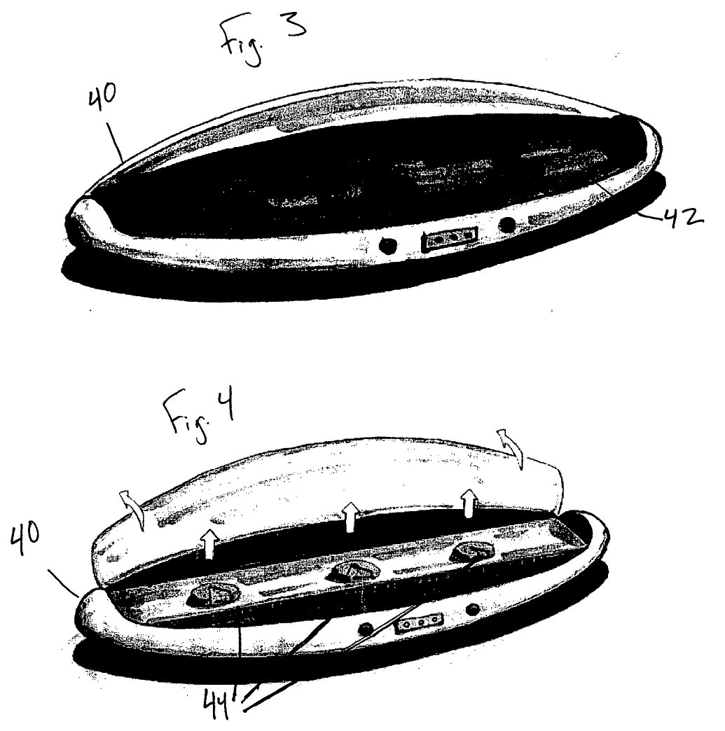

The intraoral bite spacer 10 as depicted in FIGS. 1 and 2 may be made of a medical grade polymer such as silicone rubber or any other suitable material. The bite spacer 10 has upper teeth engaging surface 12 and lower teeth engaging surface 14. Preferably, bumps or other textured surface features are provided on the engaging surfaces 12, 14 to provide a griping feature and make the wearing of the bite spacer more comfortable for extended periods of time.

In a preferred embodiment, extending from the upper teeth engaging surface 12 is a U-shaped upper lip portion 16 and extending from the lower teeth engaging surface 14 is a U-shaped lower lip portion 18. It will be recognized that numerous variations in the shape and positioning of such lip and gum interface structures can be made without departing from the scope and spirit of the present invention.

The bite spacer has a sidewall 20 between the upper lip portion 16 and the lower lip portion 18. The sidewall 20 is preferably shaped such that the U-shaped portions 16 and 18 are symmetrically angled from a front end 17 to a rear end 19 of the bite spacer 10. In this embodiment, the bite spacer 10 is effectively reversible for positioning on either the right or left side of the patient's mouth simply by turning the bite spacer upside down, in which case the upper portion 16 now interfaces with the lower teeth and the lower portion 18 now interfaces with the upper teeth. In one embodiment, the angle between the engaging surfaces 12 and 14 from front to back ranges from 5 degrees to 25 degrees and is preferably about 15 degrees.

While the preferred embodiment shows a sidewall 20 that is substantially the same width as the width of the engaging surfaces 12, 14, but narrower than the extent of the lip portions 16, 18, it will be understood that numerous variations in the structure and arrangement of the side wall 20 can be made within the spirit and scope of the present invention. For example, the sidewall 20 may be extended out beyond the width of the lip portions 16, 18 on the inside wherein the light emitting devices 22 are mounted. In the embodiment shown in FIGS. 1 and 2, a deformation zone 21 is provided in the sidewall 20 on the outside opposite wherein the light emitting devices 22 are mounted. This deformation zone 21 permits the patient to exert a biting force on the bite block without crushing the circuitry or light emitting devices by directing the biting force to the outside of the side wall 20.

Light emitting devices 22 are preferably wholly contained within the bite spacer 10 on the inside surface of the sidewall 20. In a preferred embodiment, the light emitting devices 22 are a plurality of ultra-bright light emitting diodes 22. The light emitting diodes 22 are preferably arranged in a row as shown in FIGS. 1 and 2. The number of light emitting diodes 22 may range from 1 to 4 or more. The size of the light emitting diodes 22 is preferably in the range of about 2 to 6 millimeters in diameter. In another embodiment, the light emitting devices 22 may be a light emitting polymer material or an organic polymer light emitting device. In still another embodiment, conventional light bulbs may be used provided that such bulbs are adequately mounted and sealed within the bite spacer 10 and are protected against crushing or breaking in the patient's mouth.

The bite spacer 10 is battery powered and is preferably rechargeable. In one embodiment, the bite spacer 10 employs rechargeable batteries 50 and that are electrically connected to a waterproof power switch 52 mounted in the outside of sidewall 20 as shown in FIG. 5. An inductive charging coil 54 also mounted and sealed within the sidewall 20 of the bite spacer 10, preferably opposite to the sidewall 20 from the light emitting devices 22. A control circuit 56 is preferably embedded within the bite spacer 10 and electrically coupled to the various elements as will be described. In one embodiment, the control circuit 56 includes circuitry 66 to monitor the voltage level on the batteries 50 and causes the light emitting devices 22 to blink or otherwise indicate when the batteries are in need of recharging. Alternatively, another light emitting device can be provided as a recharge indicator or an audible indicator could be provided by a piezoelectric speaker, for example.

In a preferred embodiment, the batteries 50 and light emitting devices 22 are selected such that bite spacer 10 illuminates for approximately 30 minutes to one hour before recharging is needed. The operational life of the bite spacer 10 in this embodiment is dependent upon the desired light output (measured in lumens), the current draw achievable from the batteries 50 and the thermal loss from the light emitting devices. In a preferred embodiment, as described in connection with FIG. 6, a maximum light output at least 50-100 lumens is produced by the bite spacer 10 without having the temperature of the bite spacer rise significantly above body temperature.

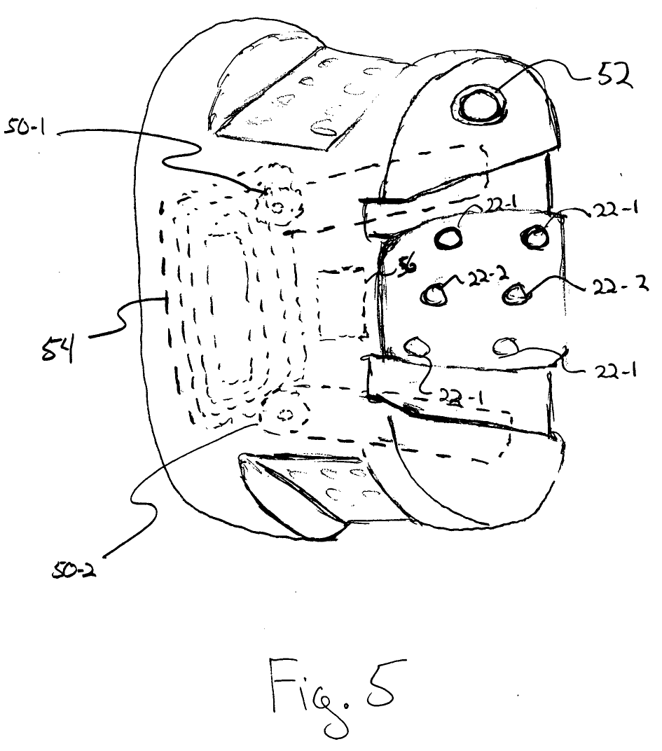

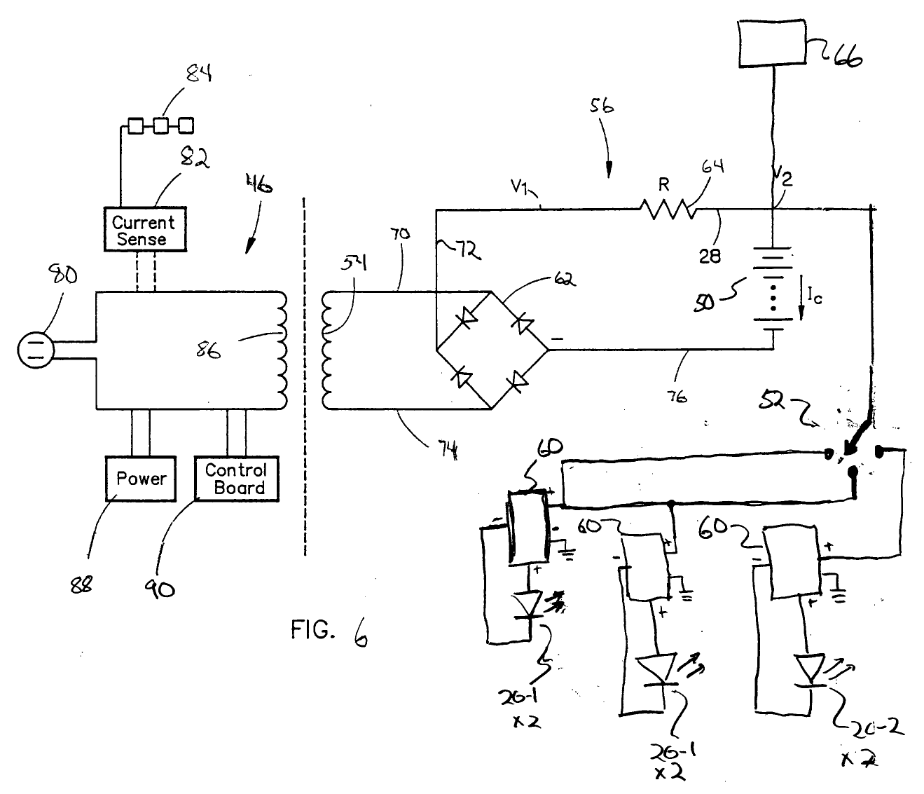

In one embodiment, the present invention includes a fully contained induction coil recharging base 40 that not only recharges multiple bite spacers 10, but also allows the bite spacers 10 to be submersed in a sterilizing solution 42. FIG. 3 depicts the recharging base 40 in a closed position that allows the bite spacers 10 to be fully immersed for cold sterilization in a sterilizing solution 42. FIG. 4 shows the recharging base 40 in an open position, depicting the multiple recharging stations 44 for a plurality of bite spacers 10. The sterilization solution 42 can be any number of cold sterilization solutions that are commercially available for dental sterilization applications. The recharging base includes recharging circuitry 46 as will be described in connection with FIG. 6.

The bite spacer 10 is preferably dimensioned to fit in the majority of adult patient mouths. The approximate dimensions of the adult bite spacer is in the range of about 4.5 cm×3 cm×3.5 cm. Bite spacers of various dimensions can be made to fit children, adolescents and patients with larger than average intraoral cavities.

In one embodiment, the bite spacer 10 includes at least one light emitting device 22 that emits an orange illumination with no blue wavelength to avoid curing photopolymerizable or composite dental materials. Preferably, the orange LED is activated by using the switch 52 in conjunction with the control circuit 56 by, for example, depressing the switch 52 twice.

In the embodiment as shown in the electrical schematic of FIG. 6, four 1 W ultra-bright white LEDs 22-1 and two ultra-bright orange LEDs 22-2, such as the model DS25 Luxeon® 1 W emitters available from LumiLeds Lighting, LLC, San Jose, Calif. The white LEDs 22-1 preferably are spaced apart by at least 2 cm in a diagonal pattern as shown in FIG. 5. The orange LEDs 22-2 also are preferably spaced apart by at least 2 cm and positioned between the white LEDs 22-1 as shown in FIG. 5. This inter-LED spacing allows each light source 22-1, 22-2 to be considered as a point heat source for purposes of thermal analysis. In this embodiment, each 1 Watt LED will experience a total temperature rise of approximately 25-30° F. during operation. Assuming the bite spacer 10 is initially at ambient temperature (72° F.), the final operation temperature of bite spacer 10 should not rise significantly above body temperature (97° F.). In this embodiment, control circuit 56 includes four 1 W LED drive modules 60, such as the MicroPuck™ Model 2009 available from LED Dynamics, Rochester, Vt., are selectively connected to the light sources 22 by power switch 52 and to the batteries 50.

In this embodiment, the switch 52 is preferably a four pole depressable waterproof switch. Two of the LED drive modules 60 are switchably connected to power two of the white LEDs 22-1 when the switch 52 is depressed once. All four of the LED drive modules 60 are switchably connected to power all four of the white LEDs 22-1 when the switch 52 is depressed twice. Two of the LED drive modules 120 are switchably connected to provide power to the orange LEDs 22-2 when the switch 52 is depressed three times. Depressing the switch 52 a fourth time would turn off the light sources 22.

Preferably, the battery 50 is a rechargeable battery comprised of two AAA rechargeable NiMH batteries 50-1 and 50-2 positioned as shown in FIG. 5. Each AAA battery preferably has a rating of at least 600 mAhours and is capable of providing continuous current at two times its maximum rating. The recharging coil 54 is electrically connected to the batteries through associated rectifier circuitry 62 that is preferably part of the control circuitry 56. Although numerous arrangements can be made for the rechargeable battery 50, an example of one such inductively rechargeable battery arrangement is shown in U.S. Pat. No. 5,959,433, the disclosure of which is hereby incorporated by reference. The circuitry 46 of the recharging base 40 can be implemented in accordance with the teachings of U.S. Pat. No. 5,959,433, for example, to permit trickle charging of the rechargeable battery 50.

A preferred embodiment of the circuitry is shown in FIG. 6, pick-up coil 54, bridge rectifier 62, a voltage test point V₁, current limiting resistor 64 and the voltage test point V₂. The pick-up coil 54 is sized proportionately to allow it to fit inside the wall 20 of bite spacer 10. One node 70 of the pick-up coil 54 is connected to the bridge rectifier 62 with another node 72 of the bridge rectifier 62 being connected to the resistor 64. Another side of the bridge rectifier 62 is connected to the other node 74 of pick-up coil 54 with the last node 76 of the bridge rectifier 62 being connected to the battery 50.

Typically, the pick-up coil 54 will be a coil of wire having X number of turns depending upon the voltage required at V₁. Pick-up coil 54 could be a coil of wire or it could be an etched rigid or flexible circuit board in an inductive pattern. Further, coil 54 could be comprised of strands of wire braided together, copper braid, or a molded interconnect type of device that would be a plated-on type of inductor in various configurations. The bridge rectifier 62 is comprised of independent silicone diodes, but could also be an actual bridge rectifier semi-conductor circuit that is of one-piece type design. The value of the bridge rectifier should be rated two times the maximum current expected therethrough. The size of the current limited resistor 64 is dependent upon the speed with which it is desired to charge the battery 50. Typically, resistor 64 should be of a power type resistor such as normal wire wound construction.

Battery charger circuitry 46 includes the A/C or D/C input 80, as illustrated in FIG. 6. A current sense circuit 82 is the sensing circuit that detects when the coil 54 is at its maximum load, at which time it will illuminate the charger LEDs 84 on charger base 40 so that a person will know that he/she has maximum power at the point when the LEDs 84 are the brightest. A charging coil 86 of the battery charger 46 inductively couples to charging coil 54 in the bite spacer 10. An on-off LED 88 displays when the charger is plugged into A/C or D/C power. Charger circuitry 46 also includes a control board 90 consisting of a switching power supply that will boost the voltage and/or frequency of the A/C on the primary or charger coil side.

The primary coil 86, when energized, has A/C current running through it which will create magnetic flux lines that will allow another coil in the vicinity of it to pick up some of that voltage and the voltage will be induced into the secondary coil 54 and provide a current therein. For each individual battery, the pick-up coil 54 will be sized according to the voltage required with the charging coil 86 having voltage and frequency sufficient to allow the pick-up coil 54 to be as small as possible and permit it to fit inside the bite spacer 10. The current sense board 82 not only will illuminate the charging LEDs 84 to indicate maximum power, but it will also be able to sense if the coil is overloaded or overheated. Preferably, the current sense board 82 is also able to sense whether or not a bite spacer 10 is placed in the recharging station 40, as opposed to some other metallic object which would induce some current as well. It is preferable that other protective devices be included in the charger circuitry 46 such as thermal shut-downs, polyswitches, or fuses. It is also preferred that there be a start button on the outside of the recharge station 40 to ensure additional safety to initiate the charge. The housing of the recharge station 40 is preferably plastic, and not conductive on its exterior. The recharging station 40 may also be provided with some electrical shielding at the outer portions thereof to prevent the induction of current into surrounding items around the recharging station 40.

When charging coil 86 is energized, it will create magnetic flux lines which will induce a current in the pick-up coil 54. After the current is rectified through the rectifier 62, a voltage is created at V₁ that is equivalent to approximately 1.6 volts per cell of the battery pack. This number is essentially the maximum voltage an individual Ni-CAD or Ni-MH cell will reach under charge. The current limiting resistor 64 is such that the voltage drop thereacross sets the current charge that actually goes into the battery cells. This is defined by the equation: I_{c}=V₁−V₂/R. In other words, charge current I_{c} equals the voltage of V₁ minus the voltage of V₂ divided by the resistance.

Although preferred embodiments of the present invention have been described in the specification, it will be recognized that numerous changes can be made to the preferred embodiment which are still intended to be covered by the scope of the claims for the present invention.

1. An intraoral apparatus for illuminating a patient's mouth comprising:
a bite spacer having a pair of teeth engaging structures vertically spaced apart by a spacer structure that includes a side wall;
at least one self-contained light emitting device operably mounted in the side wall; and
a battery source positioned within the bite spacer and providing electrical power to the plurality of light emitting device,
whereby the bite spacer is positionable between the teeth on either side of the patient's mouth such that the light emitting devices illuminate the other side of the patient's mouth.

2. The apparatus of claim 1, wherein the light emitting device is a light emitting diode.

3. The apparatus of claim 1, wherein the battery source is a rechargeable battery.

4. The apparatus of claim 3, further comprising an induction charging circuit positioned within the bite spacer and electrically connected to the rechargeable battery such that the rechargeable battery is rechargeable without connections external to the bite spacer.

5. The apparatus of claim 1, wherein the battery source and the light emitting device is sealed within the bite spacer.

6. The apparatus of claim 1, wherein the teeth retaining structures include a pair of generally U-shaped channels.

7. The apparatus of claim 6, wherein the U-shaped channels are symmetrically angled from a front end to a rear end of the bite spacer.

8. The apparatus of claim 1, further comprising a waterproof power switch mounted in the bite spacer and electrically coupled between the battery power source and the light emitting devices.

9. The apparatus of claim 1, wherein there are a plurality of light emitting devices and at least one of the light emitting devices emits light at a frequency range that does not activate photopolymerizable materials.

10. The apparatus of claim 9, further comprising a waterproof power switch mounted in the bite spacer and electrically coupled between the battery power source and the light emitting devices that selectively activates the at least one light emitting device that emits light at the frequency range that does not activate photopolymerizable materials.

11. The apparatus of claim 1, further comprising means electrically coupled to the battery power source for indicating a low battery charge.

12. The apparatus of claim 1 wherein the battery power source and the light emitting devices are selected such that the battery power source has a capacity to illuminate the light emitting devices for a period of at least one-half hour with a luminous intensity of at least 50 lumens and without causing the apparatus to rise in temperature significantly above human body temperature.

13. An intraoral apparatus for illuminating a patient's mouth comprising:
a bite spacer having a pair of teeth engaging structures vertically spaced apart by a spacer structure that includes a side wall;
at least one self-contained light emitting device operably mounted in the side wall;
a rechargeable battery positioned within the bite spacer and providing electrical power to the at least one light emitting device; and
an induction charging circuit positioned within the bite spacer and electrically connected to the rechargeable battery,
such that the rechargeable battery is rechargeable without connections external to the bite spacer.

14. The apparatus of claim 13, wherein the bite spacer is made of medical grade polymer and the rechargeable battery, the charging circuit and the at least one light emitting device are sealed within the bite spacer.

15. The apparatus of claim 13, further comprising a waterproof power switch mounted in the bite spacer and electrically coupled between the battery and the at least one light emitting device.

16. The apparatus of claim 13, wherein the teeth retaining structures include a pair of generally U-shaped channels.

17. The apparatus of claim 16, wherein the U-shaped channels are symmetrically angled from a front end to a rear end of the bite spacer.

18. The apparatus of claim 1 wherein the rechargeable battery and the at least one light emitting device are selected such that the battery power source has a capacity to illuminate the light emitting devices for a period of at least one-half hour with a luminous intensity of at least 50 lumens and without causing the apparatus to rise in temperature significantly above human body temperature.

19-20. (canceled)
